(19) United States
(12) Patent Application Publication
(10) Pub. No.: US 2022/0150753 A1
(43) Pub. Date: May 12, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Masamichi KOIKE, Kanagawa (JP)

(73) Assignee: FUJIFILM Business Innovation Corp., Tokyo (JP)

(21) Appl. No.: 17/319,069

(22) Filed: May 12, 2021

(30) Foreign Application Priority Data
Nov. 10, 2020 (JP) 2020-187442

(51) Int. Cl. H04W 28/02; H04B 7/155; H04L 12/46

(52) U.S. Cl. CPC H04W 28/0289; H04L 12/4641; H04B 7/155

(57) ABSTRACT

An information processing apparatus includes a processor configured to: in a network environment including plural individual networks, one or plural devices being connected to each of the plural individual networks, a user terminal being connected to one of the plural individual networks, determine plural route options, based on connecting information and configuration information, the connecting information indicating association between the user terminal and a connecting device, the connecting device being one of the plural devices and being a device to be connected and used by the user terminal, the configuration information indicating an individual network to which the user terminal is connected and indicating an individual network to which the connecting device is connected, the plural route options being options of routes which each connect the user terminal and the connecting device and which each include a repeater device that transfers data between the user terminal and the connecting device; select a route from the plural route options, based on load information indicating a load of the repeater device in each of the plural route options, the load of the repeater device included in the selected route being smaller than the load of another repeater device; and control connection between the user terminal, the repeater device, and the connecting device included in the selected route so as to send and receive the data in accordance with the selected route.

### CROSS-REFERENCE TO RELATED APPLICATIONS

This application is based on and claims priority under 35 USC 119 from Japanese Patent Application No. 2020-187442 filed Nov. 10, 2020.

### BACKGROUND

### (i) Technical Field

The present disclosure relates to an information processing apparatus and a non-transitory computer readable medium.

### (ii) Related Art

In a network environment of a broadband communication network, such as the Internet or a wide area network (WAN), when sending data from a sender device to a receiver device, a route from the sender device to the receiver device is determined. A technology for constructing a communication route from a sender device to a parent terminal, which is a receiver device, is known (see Japanese Unexamined Patent Application Publication No. 2007-324674, for example). This technology is concerned with a communication route construction method including a communication route broadcasting/multicasting step. In this communication route construction method, in a communication network including a parent communication terminal, which is a parent station, and multiple child communication terminals, which are child stations, a certain child communication terminal constructs a communication route to the parent communication terminal. In the communication route broadcasting/multicasting step, a child communication terminal which is already connected to the communication network and for which a communication route to the parent communication terminal has already been constructed broadcasts/multicasts the following communication signal to the communication network. The communication signal indicates information about a communication route having a smaller hop count than the preset maximum hop count of already constructed communication routes to the parent communication terminal.

### SUMMARY

When sending and receiving information between devices via a network, such as when sending data from a sender device to a receiver device in a network environment, the information is transferred via network devices, such as a router, a gateway, and a repeater server. When sending and receiving information via network devices, a route from a sender device to a receiver device is determined. Each network device transfers data to the next network device, and information about routing of transferring data has been determined in accordance with the network configuration. The route is determined based on this routing information.

Performing access control for restricting access only to a specific user in a specific network involves complicated processing. Additionally, if access is concentrated on a specific network device, the processing load of this network device is increased. There is thus room for improvement in sending and receiving data in a network environment.

Aspects of non-limiting embodiments of the present disclosure relate to an information processing apparatus and a non-transitory computer readable medium which are able to restrict access to a specific user and to reduce a load of a repeater device that transfers data between devices, compared with when a route is determined in accordance with the network configuration.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: in a network environment including plural individual networks, one or plural devices being connected to each of the plural individual networks, a user terminal being connected to one of the plural individual networks, determine plural route options, based on connecting information and configuration information, the connecting information indicating association between the user terminal and a connecting device, the connecting device being one of the plural devices and being a device to be connected and used by the user terminal, the configuration information indicating an individual network to which the user terminal is connected and indicating an individual network to which the connecting device is connected, the plural route options being options of routes which each connect the user terminal and the connecting device and which each include a repeater device that transfers data between the user terminal and the connecting device; select a route from the plural route options, based on load information indicating a load of the repeater device in each of the plural route options, the load of the repeater device included in the selected route being smaller than the load of another repeater device; and control connection between the user terminal, the repeater device, and the connecting device included in the selected route so as to send and receive the data in accordance with the selected route.

### BRIEF DESCRIPTION OF THE DRAWINGS

An exemplary embodiment of the present disclosure will be described in detail based on the following figures, wherein:

FIG. 1 is a schematic diagram illustrating the configuration of a network system according to the exemplary embodiment;

FIG. 2 illustrates an example of the configuration of a guide post;

FIG. 3 illustrates an example of the configuration of a virtual device;

FIG. 4 illustrates an example of the configuration of a site device;

FIG. 5 illustrates an example of the configuration of a user device;

FIG. 6 illustrates an example of connection request information;

FIG. 7 illustrates an example of network configuration information;

FIG. 8 illustrates an example of load information;

FIG. 9 is a flowchart illustrating an example of processing executed by the guide post according to the exemplary embodiment; and

FIG. 10 is a schematic diagram for explaining the selection of a route.

### DETAILED DESCRIPTION

An exemplary embodiment to carry out the disclosure will be described below in detail with reference to the accompanying drawings. In the drawings, elements functioning and operated in the same manner are designated by like reference numeral and operations functioning and executed in the same manner are also designated by like reference numeral, and an explanation thereof may not be repeated. The drawings are only schematically illustrated to such a degree as to sufficiently understand the disclosure and are not for limiting the disclosure. In the exemplary embodiment, an explanation of the configurations of elements that are not directly related to the disclosure and those of elements that are already known may be omitted.

In the disclosure, “devices” include electronic devices containing a computer having a communication function. Examples of the devices are a server and a personal computer (PC). Another example of the devices is a network device, such as a router that receives data from a sender device and transfers it to another device. Another example of the devices is an image forming device containing a computer having a communication function and also having an image processing function and a communication function. The image processing function includes an image copying function of copying a document, an image forming function including an image printing function of printing data of an input document, and an image reading function of reading (scanning) a document as an image and forming the read (scanned) document into data. The communication function includes a wired communication function and a wireless communication function. The wired communication function is a function of sending and receiving data by means of wired connection or direct connection with an external device. The wireless communication function is a function of sending and receiving data by means of wireless connection with an external device.

In the disclosure, “user terminals” include communication terminals having a wired communication function or a wireless communication function. The wireless communication function includes a function that can perform communication using a mobile communication system called the fifth generation (5G) and a function that can perform communication using a mobile communication system called long term evolution (LTE).

In the disclosure, “a communication network” includes a network that allows devices to send and receive data therebetween using a wired or wireless communication circuit. Examples of the communication network are a narrowband communication network and a broadband communication network. The narrowband communication network, such as a local area network (LAN), implements data sending and receiving between various sites of a company, for example. The broadband communication network, such as the Internet or a wide area network (WAN), implements data sending and receiving via a public communication circuit.

Devices that transfer data are included in a network environment connected to a communication network. The devices included in the network environment are operated as nodes in the communication network. A node identifies the address of a network connected to this node and transfers information about this network address to an adjacent node. The adjacent node transfers the information about this network address and also information about the network address of this adjacent node to another adjacent node. In this manner, when transferring data to a target address, every node is able to identify to which node the data is to transfer, thereby achieving communication in the network environment.

For example, in the network environment using transmission control protocol/Internet protocol (TCP/IP), devices can be connected to each other using IP addresses (identification information). To connect the devices, a routing protocol is used for selecting a route to connect the devices. More specifically, according to this routing protocol, the selection of a route (which is also called routing) is performed to achieve communication from a sender device to a receiver device. Between adjacent routers, a route can be specified from a routing table about the adjacent routers and from a hop count (the number of devices which transfer data). Between adjacent autonomous systems (aSs) operated by an organization, a route can also be specified from a routing table about the aSs and from a hop count. As the routing protocol, an interior gateway protocol (IGP) and an exterior gateway protocol (EGP) are known. As a dynamic routing protocol, open shortest path first (OSPF), routing information protocol (RIP), and border gateway protocol (BGP) are known.

In recent network environments, a virtual network may be constructed. A virtual network is a network which is at least partially virtualized and includes at least some virtualized devices in a virtual space called a cloud.

In a virtual network, it is not easy to perform access control even if restrictions are desirably imposed on connection from a specific device. Device connection is specified by information about the connection relationships between devices, which is called routing. Routing is determined independently of access control, and once it is fixed, an enormous amount of processing is required to change this routing. Especially in a network environment including a virtual network, it is difficult to perform access control via the virtual network. Additionally, in a virtual network, access is concentrated on a virtual network device, such as a virtual gateway, which is included in a virtual network to send and receive data. This may dynamically change the usage situation of the network and increase the processing load or decrease the performance. In a route including a device (may be a virtual device) with an increased load, the time taken to transfer data becomes longer, which may be inconvenient for a user.

In view of this situation, in the exemplary embodiment, an information processing apparatus that can reduce a load of a repeater device which transfers data between devices in a network environment is provided. In the exemplary embodiment, the network environment includes plural individual networks, which are communication networks. One or plural devices are connected to each of the plural individual networks. A user terminal is connected to one of the plural individual networks. In this network environment, the information processing apparatus determines plural route options, based on connecting information and configuration information. The connecting information indicates the association between the user terminal and a connecting device. The connecting device is one of the plural devices and is a device to be connected and used by the user terminal. The configuration information indicates an individual network to which the user terminal is connected and also indicates an individual network to which the connecting device is connected. The plural route options are options of routes which each connect the user terminal and the connecting device and which each include a repeater device that transfers data between the user terminal and the connecting device. The information processing apparatus selects a route from the plural route options, based on load information indicating a load of the repeater device in each of the plural route options. The load of the repeater device included in the selected route is smaller than that of another repeater device. The information processing apparatus controls connection between the user terminal, the repeater device, and the connecting device included in the selected route so as to send and receive the data in accordance with the selected route.

By using the information processing apparatus according to the exemplary embodiment, a load of a repeater device that transfers data between devices is reduced. Additionally, as a result of selecting a route so as to reduce the load of a repeater device, the load of the overall route is decreased. This achieves data transfer with a lighter load (with a reduced time, for example).

### (Network System)

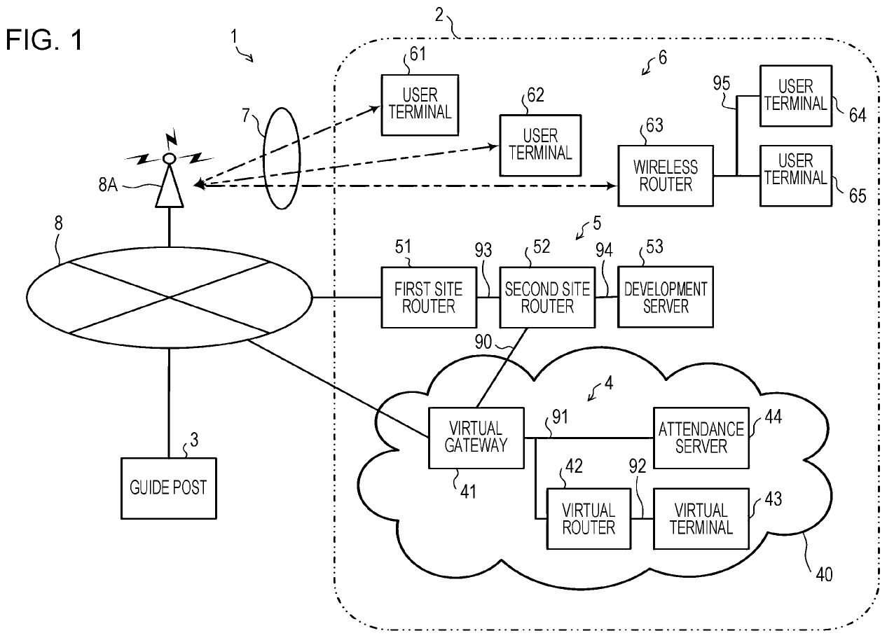

FIG. 1 is a schematic diagram illustrating the configuration of a network system 1 as a network environment according to the exemplary embodiment.

In the exemplary embodiment, a description will be given, assuming that each device stores IP addresses for accessing to another device and that, when sending data, information about the IP address of a sender device and the IP address of a receiver device is sent together. It is also assumed that a device can connect to another device via an individual network by using a virtual private network (VPN) function. The VPN function is a known technology and an explanation thereof is thus omitted.

As shown in FIG. 1, the network system 1 includes plural devices, such as virtual devices 4, site devices 5, and user devices 6. The virtual devices 4 are at least partially virtualized devices. The site devices 5 send and receive data at sites, such as organizations and departments of a company. A user device 6 sends an access request to another device. As a specific device, the network system 1 also includes a guide post 3 connected to a broadband network 8, such as the Internet, which is as an example of a broadband communication network. An access point 8A for wirelessly sending and receiving data between the user devices 6 and the broadband network 8 is connected to the broadband network 8. The access point 8A serves as a device that transfers data between a wireless communication network 7, such as 5G and LTE, and the broadband network 8, such as the Internet.

As stated above, the virtual devices 4 are at least partially virtualized devices. The virtual devices 4 can be constructed in a cloud 40. That is, the virtual devices 4 can use devices, such as virtual network devices, servers, and terminal devices, constructed in the broadband network 8 by using a cloud computing technology. More specifically, the virtual devices 4 can use such devices in the broadband network 8 as virtual computer resources like devices constructed at a given site, such as an organization or a department of a company.

In the exemplary embodiment, the virtual devices 4 include a virtual gateway 41, a virtual router 42, a virtual terminal 43, and an attendance server 44 constructed in the cloud 40. The virtual gateway 41 is connectable to the broadband network 8. The virtual gateway 41 is also connectable to the virtual terminal 43 via the virtual router 42 and is also connectable to the attendance server 44.

The virtual gateway 41 is also connectable to a second site router 52, which serves as a site device 5, via a dedicated line 90.

The site devices 5 are disposed at given sites, such as organizations and departments of a company. In the exemplary embodiment, the site devices 5 include a first site router 51, a second site router 52, and a development server 53. The development server 53 is connectable to the broadband network 8 via the second site router 52 and the first site router 51.

The user devices 6 are each operated by a user to send an access request to another device. In the exemplary embodiment, the user devices 6 include user terminals 61, 62, 64, and 65 and a wireless router 63. The user terminals 61 and 62 each include a subscriber identity module (SIM) and has a communication function of connecting to the wireless communication network 7, such as 5G and LTE. The wireless router 63 is a SIM router and has a communication function of connecting to the wireless communication network 7. The user terminals 64 and 65 do not have a communication function of connecting to the wireless communication network 7, but can be connected thereto by connecting to the wireless router 63.

In the network system 1, each device connects to an individual network to send and receive data to and from another device. That is, the network system 1 includes multiple networks to which corresponding devices can be connected, and each device can send and receive data to and from another device by connecting to a corresponding network. In the exemplary embodiment, network configuration information indicating a network to which each device is connectable in the network system 1 is employed. The multiple networks included in the network system 1 will be called individual networks. An individual network corresponds to electrical wire electrically connecting adjacent devices and include a single connection line, such as a dedicated circuit (dedicated line). Individual networks may be a broadband communication network, such as the Internet, and a narrowband communication network, such as a LAN.

Information indicating a network to which each device is connectable will be explained below more specifically.

The guide post 3 is connectable to the broadband network 8. As information about the individual network of the guide post 3, information indicating the broadband network 8 is thus used. The access point 8A serves as a device that transfers data between the wireless communication network 7 and the broadband network 8. As information about the individual network of the access point 8A, information indicating the wireless communication network 7 and the broadband network 8 is thus used.

The virtual gateway 41, which is one of the virtual devices 4, is connectable to the broadband network 8, and information indicating the broadband network 8 is thus used as information about an individual network of the virtual gateway 41. The virtual gateway 41 is also connectable to a network constructed between the virtual gateway 41 and each of the virtual router 42 and the attendance server 44. This network will be called a virtual network 91 (hereinafter simply called the virtual NT 91). Information indicating the virtual NT 91 is also used as information about an individual network of the virtual gateway 41. The virtual gateway 41 is also connectable to the dedicated line 90, and information indicating the dedicated line 90 is also used as information about an individual network of the virtual gateway 41.

The virtual router 42 is connectable to the virtual NT 91, and information indicating the virtual NT 91 is thus used as information about an individual network of the virtual router 42. The virtual router 42 is also connectable to a network constructed between the virtual router 42 and the virtual terminal 43 (such a network will be called a virtual router LAN 92). Information indicating the virtual router LAN 92 is also used as information about an individual network of the virtual router 42.

The virtual terminal 43 is connectable to the virtual router LAN 92. Information indicating the virtual router LAN 92 is thus used as information about the individual network of the virtual terminal 43.

The attendance server 44 is connectable to the virtual NT 91. Information indicating the virtual NT 91 is thus used as information about the individual network of the attendance server 44.

The first site router 51, which is one of the site devices 5, is connectable to the broadband network 8. Information indicating the broadband network 8 is thus used as information about an individual network of the first site router 51. The first site router 51 is also connected to a network constructed between the first site router 51 and the second site router 52 (such a network will be called a first site LAN 93). Information indicating the first site LAN 93 is also used as information about an individual network of the first site router 51.

The second site router 52 is connectable to the first site LAN 93, and information indicating the first site LAN 93 is thus used as information about an individual network of the second site router 52. The second site router 52 is also connectable to the dedicated line 90, and information indicating the dedicated line 90 is also used as information about an individual network of the second site router 52. The second site router 52 is also connectable to a network constructed between the second site router 52 and the development server 53 (such a network will be called a second site LAN 94). Information indicating the second site LAN 94 is also used as information about an individual network of the second site router 52.

The development server 53 is connectable to the second site LAN 94, and information indicating the second site LAN 94 is thus used as information about the individual network of the development server 53.

The user terminals 61 and 62, which are devices of the user devices 6, are connectable to the wireless communication network 7. Information indicating the wireless communication network 7 is thus used as information about the individual network of each of the user terminals 61 and 62.

The wireless router 63 is connectable to the wireless communication network 7, and information indicating the wireless communication network 7 is thus used as information about an individual network of the wireless router 63. The wireless router 63 is also connectable to a network constructed between the wireless router 63 and each of the user terminals 64 and 65 (such a network will be called a wireless router LAN 95). Information indicating the wireless router LAN 95 is also used as information about an individual network of the wireless router 63.

The user terminals 64 and 65 are connectable to the wireless router LAN 95, and information indicating the wireless router LAN 95 is thus used as information about the individual network of each of the user terminals 64 and 65.

Routes connecting devices connected to the above-described individual networks, that is, routings, are managed by the guide post 3. Hence, a network environment including devices managed by the guide post 3 can be regarded as a virtual LAN 2.

Although the guide post 3 is connected to the broadband network 8 in FIG. 1, it may not necessarily be connected thereto. The guide post 3 may be a virtual device. More specifically, the guide post 3 may be constructed in the cloud 40 as a control post connectable to the broadband network 8.

The configuration of the network system 1 shown in FIG. 1 is only an example, and the disclosure is not limited thereto. More devices or less devices may be included in the network system 1.

### (Guide Post)

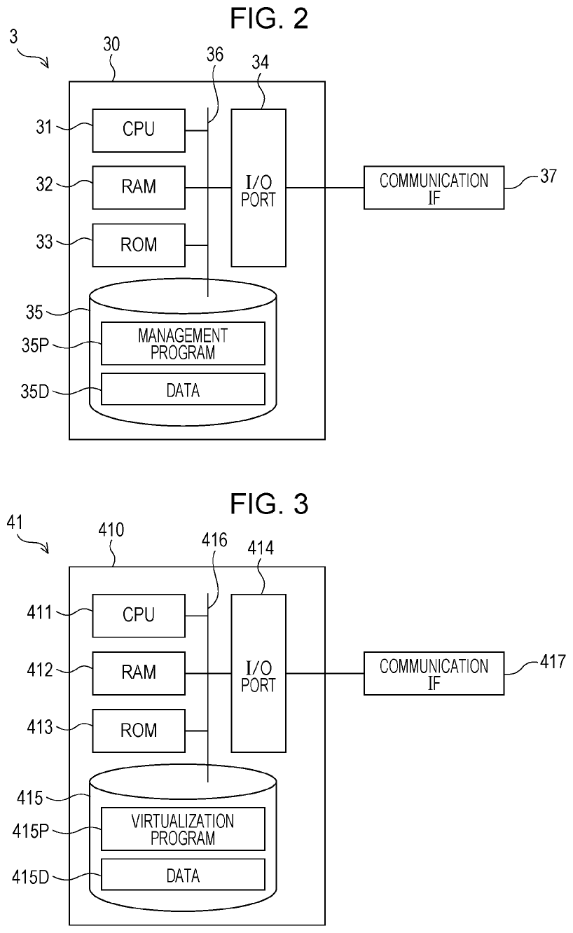

An example of the configuration of the guide post 3 will be described below with reference to FIG. 2. The guide post 3 is a device that manages the virtual LAN 2. The guide post 3 may be implemented by a general-purpose computer, such as a server or a PC.

The guide post 3 includes a computer unit 30. The computer unit 30 includes a central processing unit (CPU) 31, a random access memory (RAM) 32, a read only memory (ROM) 33, and an input/output (I/O) port 34. These elements are connected to each other via a bus 36. An auxiliary storage device 35, such as a hard disk drive (HDD) or a non-volatile flash memory, is connected to the bus 36. A communication interface (IF) 37 is connected to the I/O port 34. Various items of data 35D to be used by the guide post 3 are stored in the auxiliary storage device 35.

A management program 35P is stored in the auxiliary storage device 35. The CPU 31 reads the management program 35P from the auxiliary storage device 35 and loads it into the RAM 32 and executes it. This makes the guide post 3 operate as a management device. The management program 35P may be stored in a recording medium, such as compact disc-read only memory (CD-ROM) and be provided from the recording medium. The management program 35P includes a program for dynamically controlling route selection (routing) in the virtual LAN 2 to select a route from a sender device to a receiver device. Dynamic routing control will be discussed later.

### (Virtual Devices)

The configuration of the virtual devices 4 will be discussed below. The virtual devices 4 can be implemented by dedicated devices that execute functions dedicated to the corresponding virtual devices 4 or by general-purpose computers, such as servers and PCs.

An example of the configuration of the virtual gateway 41 among the virtual devices 4 is shown in FIG. 3. The virtual gateway 41 is operated in the cloud 40 and executes processing for centrally controlling the sending and receiving of information to and from user terminals via the broadband network 8.

The virtual gateway 41 includes a computer unit 410. The computer unit 410 includes a CPU 411, a RAM 412, a ROM 413, and an I/O port 414. These elements are connected to each other via a bus 416. An auxiliary storage device 415, such as an HDD or a non-volatile flash memory, is connected to the bus 416. A communication IF 417 for communicating with external devices is connected to the I/O port 414. Individual networks such as the broadband network 8, the dedicated line 90, and the virtual NT 91 (FIG. 1) are connectable to the communication IF 417. Various items of data 415D to be used by the virtual gateway 41 are stored in the auxiliary storage device 415.

A virtualization program 415P is stored in the auxiliary storage device 415. The virtualization program 415P includes a program for implementing a gateway function of operating a computer as a gateway and a program for implementing a virtualization function of operating a computer in the cloud 40. The gateway function and the virtualization function are known functions and a detailed explanation thereof is thus omitted. The CPU 411 reads the virtualization program 415P from the auxiliary storage device 415 and loads it into the RAM 412 and executes it. This allows the virtual gateway 41 to operate as a gateway in a virtual manner in the cloud 40.

The virtual gateway 41 has a communication function of transferring data between different individual networks, and determines a route from a sender device to a receiver device in accordance with route selection (routing) controlled by the guide post 3. Controlling of route selection (routing) by the guide post 3 will be discussed later.

The virtual gateway 41 may have a security function. An example of the security function is an intrusion prevention system (IPS) having a function of detecting a malicious attack, such as a malicious packet, from an external source, and blocking it and also preventing falsification of an access log. Another example of the security function is an instruction detection system (IDS) that monitors network communication and detects possible incidents and serious threats, such as malicious access and attacks. An antivirus function and a data loss/leak prevention function are also examples of the security function. Security functions, such as IPS/IDS, antivirus, and data loss/leak prevention functions, are known technologies, and a detailed explanation thereof is thus omitted.

The virtual router 42, the virtual terminal 43, and the attendance server 44, which are other examples of the virtual devices 4, can be implemented by dedicated devices that execute functions dedicated to the corresponding virtual devices 4 or by general-purpose computers, such as servers and PCs. A detailed explanation of the configurations of the virtual router 42, the virtual terminal 43, and the attendance server 44 is omitted.

As in the virtual gateway 41, the virtual router 42 is operated in the cloud 40. The virtual router 42 has a router function including a communication function of transferring data between different individual networks, and determines a route in accordance with route selection (routing) controlled by the guide post 3. The router function is a known technology and a detailed explanation thereof is thus omitted. The virtual router 42 is connectable to the virtual NT 91 and the virtual router LAN 92, as shown in FIG. 1.

The virtual terminal 43 is a virtual user terminal device. More specifically, a general-purpose computer used by a user is implemented as the virtual terminal 43 operating in the cloud 40. The virtual terminal 43 is connectable to an individual network such as the virtual router LAN 92, as shown in FIG. 1.

The attendance server 44 is a virtual server device. More specifically, a server device that conducts attendance management is implemented as the attendance server 44 operating in the cloud 40. The attendance server 44 is connectable to an individual network such as the virtual NT 91, as shown in FIG. 1.

### (Site Devices)

The configuration of the site devices 5 will be described below. The site devices 5 can be implemented by dedicated devices that execute functions dedicated to the corresponding site devices 5 or by general-purpose computers, such as servers and PCs.

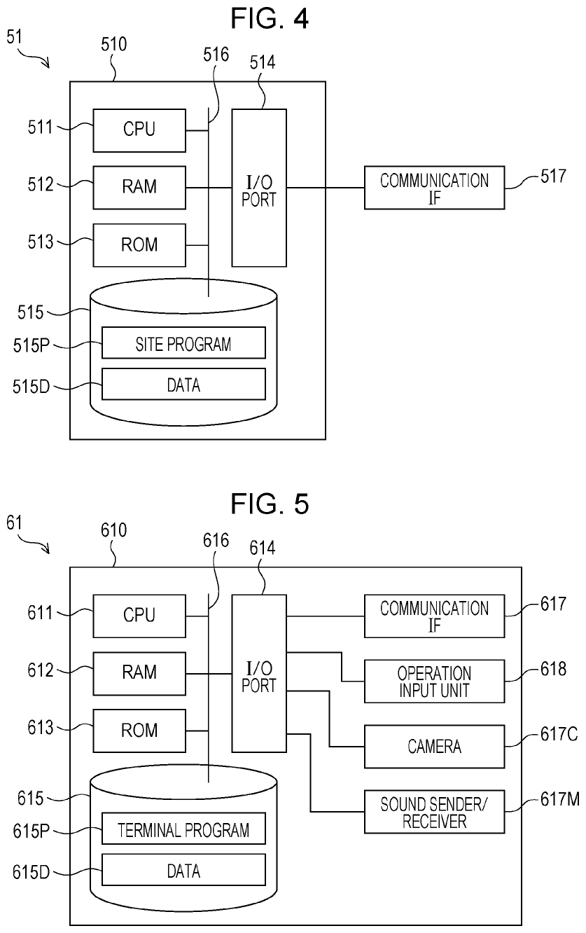

An example of the configuration of the first site router 51 among the site devices 5 is shown in FIG. 4. The first site router 51 is a device installed at a site, such as an organization or a department of a company. The first site router 51 has a router function including a communication function of transferring data between different individual networks and determines a route in accordance with route selection (routing) controlled by the guide post 3.

The first site router 51 includes a computer unit 510. The computer unit 510 includes a CPU 511, a RAM 512, a ROM 513, and an I/O port 514. These elements are connected to each other via a bus 516. An auxiliary storage device 515 is connected to the bus 516. A communication IF 517 is connected to the I/O port 514.

A site program 515P is stored in the auxiliary storage device 515. The site program 515P includes a program for implementing a router function of operating a computer as a router. The CPU 511 reads the site program 515P from the auxiliary storage device 515 and loads it into the RAM 512 and executes it. This allows the first site router 51 to operate as a router at the site in which the first site router 51 is installed.

The first site router 51 has a function of connecting to the broadband network 8, such as the Internet, in the virtual LAN 2 under the control of the guide post 3. The first site router 51 is connectable to individual networks such as the broadband network 8 and the first site LAN 93 so as to implement a router function including a communication function of transferring data between different individual networks. The first site router 51 may function as a default gateway in the virtual LAN 2.

The second site router 52 and the development server 53, which are other examples of the site devices 5, can be implemented by dedicated devices that execute functions dedicated to the corresponding site devices 5 or by general-purpose computers, such as servers and PCs. A detailed explanation of the configurations of the second site router 52 and the development server 53 is omitted.

As in the first site router 51, the second site router 52 has a router function including a communication function of transferring data between different individual networks, and determines a route in accordance with route selection (routing) controlled by the guide post 3. The second site router 52 is connectable to individual networks such as the first site LAN 93 and the second site LAN 94, as shown in FIG. 1.

The development server 53 is a server device managed by a development department of the site. The development server 53 is connectable to the second site LAN 94, as shown in FIG. 1.

The site devices 5 may have unique functions. An example of a unique mechanism for implementing a unique function is an image processing device. The image processing device has a unit for realizing an image copying function of copying a document, a unit for realizing an image forming function including an image printing function of printing data of an input document, and a unit for realizing an image reading function of reading (scanning) a document as an image and forming the read (scanned) document into data. Examples of these units are a scanner that scans a document and a printer that prints various items of data.

### (User Devices)

The configuration of the user devices 6 will be described below. The user devices 6 can be implemented by mobile terminals carried by users or by general-purpose computers, such as servers and PCs.

Among the user devices 6, an example of the configuration of the user terminal 61 implemented by a mobile terminal is shown in FIG. 5. The user terminal 61 has a function of performing communication using a mobile communication system and is connectable to the broadband network 8 via an individual network such as the wireless communication network 7.

The user terminal 61 includes a computer unit 610. The computer unit 610 includes a CPU 611, a RAM 612, a ROM 613, and an I/O port 614. These elements are connected to each other via a bus 616. An auxiliary storage device 615 is connected to the bus 616. A communication IF 617 for communicating with external devices and an operation input unit 618, which is used by a user to check the display content and to perform input operation, are also connected to the I/O port 614. A camera 617C that captures an image of an object and a sound sender/receiver 617M, such as a microphone and a speaker, that sends and receives sound to and from a user are also connected to the I/O port 614.

A terminal program 615P for causing the user terminal 61 to function as a terminal is stored in the auxiliary storage device 615. The CPU 611 reads the terminal program 615P from the auxiliary storage device 615 and loads it into the RAM 612 and executes it. This allows the user terminal 61 to operate as a terminal. Various items of data 615D to be used by the user terminal 61 are also stored in the auxiliary storage device 615.

In the exemplary embodiment, it is assumed that the user terminal 61 is a terminal, such as a cellular phone, which accesses the broadband network 8 by wireless communication. For example, the user terminal 61 is a terminal that can connect to the broadband network 8 by VPN connection based on VPN connecting information stored in the user terminal 61. In the auxiliary storage device 615, IP addresses for accessing to other devices in the virtual LAN 2 are stored as the data 615D. When the user terminal 61 sends data, the IP address of the user terminal 61 as a sender device is sent together.

The configuration of the user terminal 62 is similar to that of the user terminal 61, and a detailed explanation thereof is thus omitted.

The wireless router 63 has a function of wirelessly connecting to the broadband network 8 and a function of connecting to other devices by means of wired connection, as shown in FIG. 1. The wireless router 63 is connectable to the broadband network 8 via an individual network such as the wireless communication network 7 and also to the user terminals 64 and 65 via an individual network such as the wireless router LAN 95 so as to implement a router function including a communication function of transferring data between different individual networks.

The user terminals 64 and 65 are examples of devices without a function of wirelessly connecting to the broadband network 8. The user terminals 64 and 65 are connectable to the wireless router 63 by means of wired connection so as to connect to the wireless router LAN 95, as shown in FIG. 1.

The user devices 6 and the virtual terminal 43 are examples of a user terminal according to an exemplary embodiment of the disclosure. The attendance server 44 and the development server 53 are examples of a connecting device according to an exemplary embodiment of the disclosure. A device that transfers data (packets) is an example of a repeater device according to an exemplary embodiment of the disclosure. The guide post 3 is an example of an information processing apparatus according to an exemplary embodiment of the disclosure. Connection request information is an example of connecting information according to an exemplary embodiment of the disclosure. Network configuration information is an example of configuration information according to an exemplary embodiment of the disclosure. Load information is an example of load information according to an exemplary embodiment of the disclosure.

### (Information About Device Connection)

An explanation will now be given of information about connection between different devices in the network system 1 according to the exemplary embodiment. The guide post 3 manages the virtual LAN 2. That is, the guide post 3 dynamically controls routing in the network system 1. More specifically, the guide post 3 performs control to determine a route from an access source device to an access destination device so as to send and receive data between the different devices.

In the exemplary embodiment, to dynamically control routing, the guide post 3 utilizes connection request information, network configuration information, and load information. The connection request information is information indicating a request to connect to the network system 1 so as to send data from a device in the virtual LAN 2 to another device in the virtual LAN 2. As the connection request information, an information set at least including information indicating an access source device (such as the name and the IP address) and information indicating an access destination device (such as the name and the IP address) in association with each other is used.

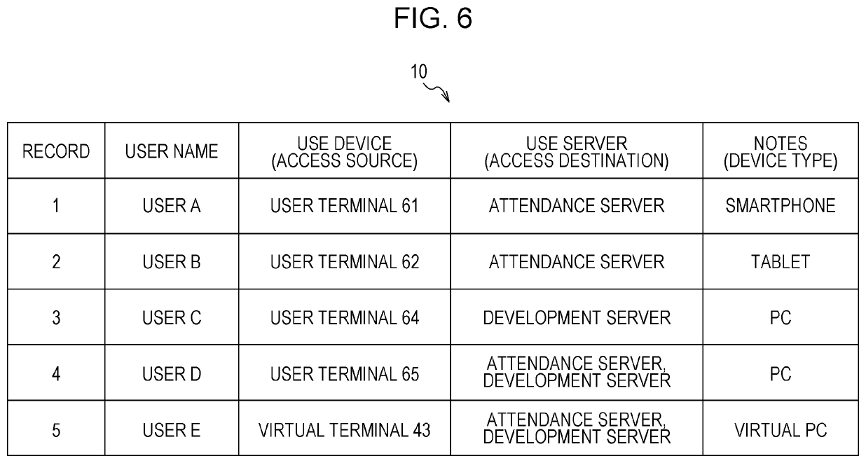

FIG. 6 illustrates an example of the connection request information.

More specifically, FIG. 6 illustrates a connection request information table 10 in which connection request information about the user terminals in the network system 1 is stored. In the connection request information table 10, fields such as a user name, a use device, a use server, and a note are registered in association with each other as a record. The user name is information indicating the name of a user operating a corresponding device. The use device is information indicating an access source device. The use server is information indicating an access destination device. The note is information indicating the device type of use device. For example, in the first record, as connection request information concerning the user terminal 61, “user A”, “user terminal 61”, “attendance server”, and “smartphone” are registered. The use device (access source) and the use server (access destination) also each indicate identification information (IP address) for identifying the device, for example.

The network configuration information is information indicating an individual network to which each device is connectable in the network system 1. As the network configuration information, an information set at least including information indicating a device (such as the name and the IP address) and information indicating an individual network (such as the name and the IP address) in association with each other is used.

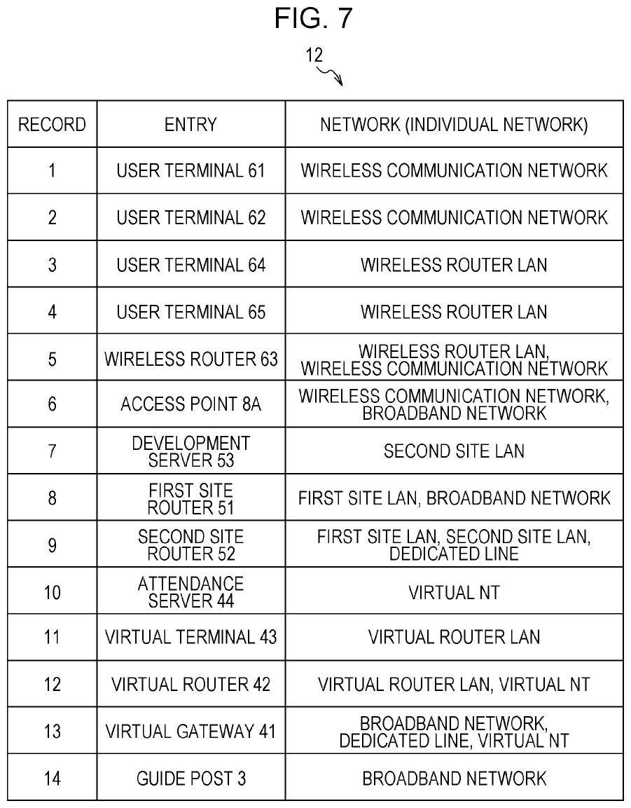

FIG. 7 illustrates an example of the network configuration information.

More specifically, FIG. 7 illustrates a network configuration information table 12 in which network configuration information about the devices in the network system 1 is stored. In the network configuration information table 12, fields such as the entry and the network are registered in association with each other as a record. The entry is information indicating the device name for identifying a corresponding device. The network is information indicating an individual network to which the corresponding device in the entry is connectable. For example, in the first record, “user terminal 61” and “wireless communication network” are registered as the network configuration information about the user terminal 61. The entry also indicates identification information (IP address) for identifying a corresponding device.

The load information is information about the load of the current device network in the network system 1. As the load information, an information set at least including information indicating a device (such as the name and the IP address) and information indicating a load index (such as the network utilization or the CPU utilization) in association with each other is used.

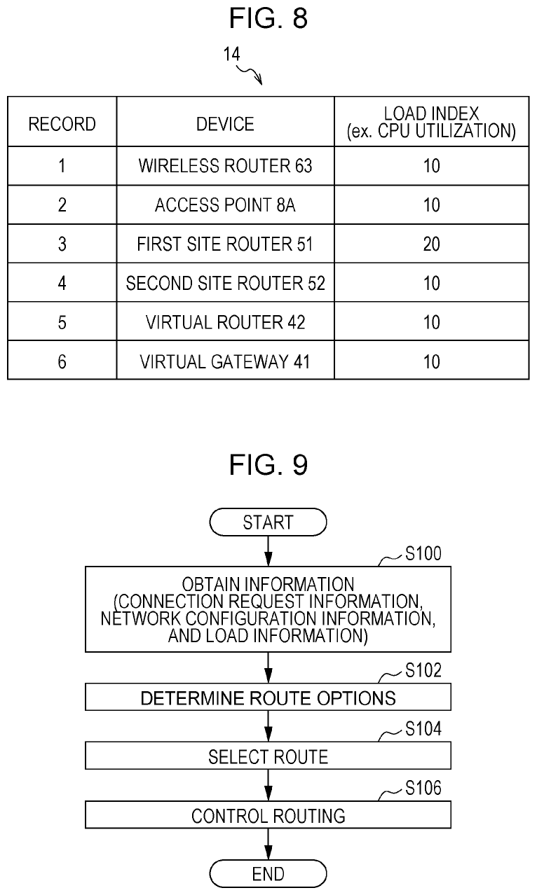

FIG. 8 illustrates an example of the load information.

More specifically, FIG. 8 illustrates a load information table 14 in which load information about each device in the network system 1 is stored.

In the load information table 14, fields such as the device and the load index are registered in association with each other as a record. The device is information indicating the name for identifying a corresponding device. The load index is information about the processing load of a corresponding device using an index, such as the network utilization or the CPU utilization. For example, in the first record, as the load information about the wireless router 63, “wireless router 63” and “10” are registered. A larger value of the load index means that the load of the device is heavier. For example, if the load index is larger than the previous one, the processing time becomes longer than before.

The guide post 3 stores the connection request information table 10, the network configuration information table 12, and the load information table 14 and updates these tables suitably. That is, the guide post 3 obtains information about an access request from a device and information from a device connected to a corresponding individual network and updates the tables on a regular or an irregular basis.

The connection request information, network configuration information, and load information in the network system 1 are changing every moment in accordance with the situation where users are using devices. It is thus desirable to independently update these items of information every time any change is made and to register the latest information.

In the exemplary embodiment, the connection request information, network configuration information, and load information are stored in the guide post 3 as tables. However, these items of information may be stored in a different location. For example, a storage device may store at least one of the connection request information, network configuration information, and load information, and the guide post 3 may obtain the corresponding information from the storage device. The connection request information formed as a table, the network configuration information formed as a table, and the load information formed as a table may individually be stored in different devices. The same information table may be divided and distributed over plural devices, or the same information table may not be divided and be stored in plural devices.

### (Operation of Network System)

The operation of the network system 1 according to the exemplary embodiment will be described below with reference to FIG. 9.

FIG. 9 is a flowchart illustrating an example of processing executed by the guide post 3. In response to an access request from a user device 6 (the user terminal 61, for example) to another device, the guide post 3 executes routing control so as to reduce the loads of devices when the devices are connected with each other. More specifically, the CPU 31 of the guide post 3 executes the processing shown in FIG. 9.

Processing will be discussed below by taking an example in which the guide post 3 controls routing from the user terminal 65 to the development server 53.

In step S100, the CPU 31 executes information obtaining processing. The CPU 31 reads the connection request information table 10, the network configuration information table 12, and the load information table 14, which are stored as the data 35D in the auxiliary storage device 35, to obtain the connection request information, network configuration information, and load information.

Then, in step S102, the CPU 31 executes route option determining processing by using the information tables obtained in step S100. This processing is processing for searching for a route, which is an array of individual networks, so as to transfer data (packets) from the user terminal 65 to the development server 53. An array of individual networks represents a route from the user terminal 65 to the development server 53 via these individual networks. That is, the CPU 31 determines an array of individual networks connected to devices from the user terminal 65 to the development server 53 by including devices which transfer data (packets) between the user terminal 65 and the development server 53.

An example of route search processing to be executed when determining route options in step S102 will be explained below. Route search processing is executed in accordance with the following processing steps.

In a first processing step, information indicating an access source device and an access destination device is obtained based on the connection request information. More specifically, the CPU 31 obtains, from the connection request information, information that the user of the user terminal 65 uses the development server 53 (the fourth record in the connection request information table 10 in FIG. 6).

In a second processing step, based on the network configuration information, the CPU 31 obtains information indicating an individual network to which each of the access source device and the access destination device is connectable (the fourth and seventh records in the network configuration information table 12 in FIG. 7). More specifically, the CPU 31 identifies the wireless router LAN 95 as the individual network to which the user terminal 65 is connectable, and sets the identified wireless router LAN 95 as a starting network in route search processing (hereinafter called a starting LAN). The CPU 31 also identifies the second site LAN 94 as the individual network to which the development server 53 is connectable, and sets the identified second site LAN 94 as a target network in route search processing (hereinafter called a target LAN).

In a third processing step, based on the network configuration information, the CPU 31 determines a combination and the order of individual networks that can connect a route from the starting LAN to the target LAN via devices, such as routers.

In a fourth processing step, the CPU 31 determines as a route option an array of individual networks from the starting LAN to the target LAN in accordance with the order of the individual networks.

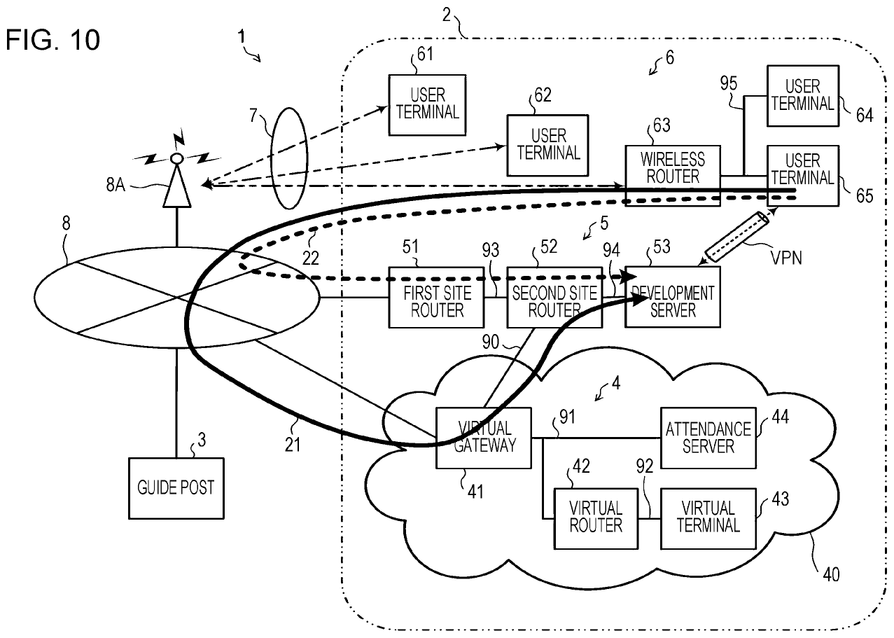

Two route options are determined, as shown in FIG. 10. A first route option 21 is a route from the user terminal 65 to the development server 53 via the wireless router 63, the access point 8A, the broadband network 8, the virtual gateway 41, and the second site router 52. A second route option 22 is a route from the user terminal 65 to the development server 53 via the wireless router 63, the access point 8A, the broadband network 8, the first site router 51, and the second site router 52.

Then, in step S104, the CPU 31 executes route selection processing. This processing is processing for selecting a route from the route options determined in step S102, based on the load information (load information table 14 in FIG. 8). More specifically, the CPU 31 calculates the total value of the current load indexes of the devices included in each of the route options. Then, the CPU 31 selects the route option whose total value is smaller than that of the other route option as the route. If three or more route options are determined, the route option whose total value is the smallest is selected as the route.

In this example, the total value of the first route option 21 is “30”, while that of the second route option 22 is “40”. The first route option 21 having a smaller total value is thus selected as the route.

Then, in step S106, the CPU 31 executes route selection (routing) control in the virtual LAN 2. This processing is processing for setting a condition (such as a routing table) for selecting a route (routing) in each of the devices which transfer packets. That is, the CPU 31 controls route selection (routing) in the devices included in a selected route so as to connect the user terminal 65 and the development server 53 based on the selected route, that is, to send and receive packets between the user terminal 65 and the development server 53.

More specifically, the CPU 31 performs control to set a condition in a device (such as a router) which transfers packets in the route selected in step S104 so that packets can be sent and received between the user terminal 65 and the development server 53 in accordance with the selected route. In this control processing, a routing table is registered in each of the devices that transfer packets so as to cause the devices to send and receive the packets via the individual networks based on the selected route.

In this manner, the guide post 3 performs control to select a route with a lighter load, based on the connection request information, network configuration information, and load information. If VPN connection between the user terminal 65 and the development server 53 is feasible, a network environment using highly confidential private connection can be constructed. That is, as a result of setting a route under the control of the guide post 3, a tunnel VPN with a reduced processing load is constructed, as shown in FIG. 10, that is, a network environment using highly confidential, reduced-load private connection is constructed.

As described above, as a result of selecting a route so as to reduce the load of devices transferring data, such as packets, the load of the overall route is decreased. This achieves packet communication, such as data transfer, with a lighter load (with a reduced time, for example).

In the network system 1, the connection request information, network configuration information, and load information are changing every moment in accordance with the situation where users are using devices. In the exemplary embodiment, it is possible to respond to such a changing network environment.

For example, it is now assumed that the load index of the virtual gateway 41 in the load information table 14 in FIG. 8 has changed from “10” to “30”. Due to this change, the total value of the current load indexes of the first route option 21 is calculated as “50”, and that of the second route option 22 is calculated as “40”. Hence, the second route option 22 having a smaller total value is selected as the route. In this manner, in the exemplary embodiment, the route can be reconfigured to bypass a device with a heavy load, and dynamic routing control is achieved in accordance with the current network environment. As a result, the optimal route with a lighter load is stably provided in accordance with the current network environment.

As described above, in the exemplary embodiment, in the virtual LAN 2, a minimal route with the smallest access to unrelated devices is constructed, based on the connection request information, network configuration information, and load information. This makes it possible to secure resources used for executing processing in the devices in the virtual LAN 2.

In the exemplary embodiment, a route is selected in accordance with the loads on devices. Hence, the load is not concentrated on a particular device, for example, a virtual device such as a virtual gateway.

In the exemplary embodiment, a route from an access source device to an access destination device is searched for so as to reduce unnecessary access to unrelated devices, thereby decreasing wasteful consumption of network resources.

In the exemplary embodiment, a route is constructed based on a connection request between devices. The security in the route is thus ensured without considering the function of an access destination device.

In the exemplary embodiment, a route is dynamically set in response to a change in the network environment, such as an increase or a decrease in the number of devices and individual networks. It is thus possible to select the optimal, latest route with a reduced load.

### [Other Exemplary Embodiments]

The technology of the disclosure has been described in detail through illustration of the above-described exemplary embodiment. However, the disclosure is not restricted to the exemplary embodiment. Various other exemplary embodiments may be employed without departing from the spirit and scope of the disclosure.

In the above-described exemplary embodiment, processing is performed as a result of executing the programs stored in the auxiliary storage devices. Alternatively, processing in the exemplary embodiment may be implemented by using hardware.

Processing in the exemplary embodiment may be recorded in a storage medium, such as an optical disc, as a program and be distributed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
in a network environment including a plurality of individual networks, one or a plurality of devices being connected to each of the plurality of individual networks, a user terminal being connected to one of the plurality of individual networks,
determine a plurality of route options, based on connecting information and configuration information, the connecting information indicating association between the user terminal and a connecting device, the connecting device being one of the plurality of devices and being a device to be connected and used by the user terminal, the configuration information indicating an individual network to which the user terminal is connected and indicating an individual network to which the connecting device is connected, the plurality of route options being options of routes which each connect the user terminal and the connecting device and which each include a repeater device that transfers data between the user terminal and the connecting device;
select a route from the plurality of route options, based on load information indicating a load of the repeater device in each of the plurality of route options, the load of the repeater device included in the selected route being smaller than the load of another repeater device; and
control connection between the user terminal, the repeater device, and the connecting device included in the selected route so as to send and receive the data in accordance with the selected route.

2. The information processing apparatus according to claim 1, wherein the processor is a processor included in a management device which is connected to one of the plurality of individual networks and which manages the plurality of devices in the network environment.

3. The information processing apparatus according to claim 1, wherein the processor is configured to select a route option as the route, a total value of loads of devices included in the selected route option being smaller than a total value of loads of devices included in another route option.

4. The information processing apparatus according to claim 2, wherein the processor is configured to select a route option as the route, a total value of loads of devices included in the selected route option being smaller than a total value of loads of devices included in another route option.

5. The information processing apparatus according to claim 3, wherein the processor is configured to select a route option as the route from the plurality of route options, a total value of loads of devices included in the selected route option is the smallest.

6. The information processing apparatus according to claim 4, wherein the processor is configured to select a route option as the route from the plurality of route options, a total value of loads of devices included in the selected route option is the smallest.

7. The information processing apparatus according to claim 1, wherein the connecting information, the configuration information, and the load information are stored in a storage of a device connected to one of the individual networks.

8. The information processing apparatus according to claim 2, wherein the connecting information, the configuration information, and the load information are stored in a storage of a device connected to one of the individual networks.

9. The information processing apparatus according to claim 3, wherein the connecting information, the configuration information, and the load information are stored in a storage of a device connected to one of the individual networks.

10. The information processing apparatus according to claim 4, wherein the connecting information, the configuration information, and the load information are stored in a storage of a device connected to one of the individual networks.

11. The information processing apparatus according to claim 5, wherein the connecting information, the configuration information, and the load information are stored in a storage of a device connected to one of the individual networks.

12. The information processing apparatus according to claim 6, wherein the connecting information, the configuration information, and the load information are stored in a storage of a device connected to one of the individual networks.

13. The information processing apparatus according to claim 1, wherein:
the user terminal includes a wireless communication terminal that is able to wirelessly connect to a broadband communication network;
at least one of the repeater device and the connecting device includes a virtual device, at least part of the virtual device being virtualized; and
an individual network to which the virtual device is connected includes a virtual network, at least part of the virtual network being virtualized.

14. The information processing apparatus according to claim 2, wherein:
the user terminal includes a wireless communication terminal that is able to wirelessly connect to a broadband communication network;
at least one of the repeater device and the connecting device includes a virtual device, at least part of the virtual device being virtualized; and
an individual network to which the virtual device is connected includes a virtual network, at least part of the virtual network being virtualized.

15. The information processing apparatus according to claim 3, wherein:
the user terminal includes a wireless communication terminal that is able to wirelessly connect to a broadband communication network;
at least one of the repeater device and the connecting device includes a virtual device, at least part of the virtual device being virtualized; and
an individual network to which the virtual device is connected includes a virtual network, at least part of the virtual network being virtualized.

16. The information processing apparatus according to claim 4, wherein:
the user terminal includes a wireless communication terminal that is able to wirelessly connect to a broadband communication network;
at least one of the repeater device and the connecting device includes a virtual device, at least part of the virtual device being virtualized; and
an individual network to which the virtual device is connected includes a virtual network, at least part of the virtual network being virtualized.

17. The information processing apparatus according to claim 5, wherein:
the user terminal includes a wireless communication terminal that is able to wirelessly connect to a broadband communication network;
at least one of the repeater device and the connecting device includes a virtual device, at least part of the virtual device being virtualized; and
an individual network to which the virtual device is connected includes a virtual network, at least part of the virtual network being virtualized.

18. The information processing apparatus according to claim 6, wherein:
the user terminal includes a wireless communication terminal that is able to wirelessly connect to a broadband communication network;
at least one of the repeater device and the connecting device includes a virtual device, at least part of the virtual device being virtualized; and
an individual network to which the virtual device is connected includes a virtual network, at least part of the virtual network being virtualized.

19. The information processing apparatus according to claim 7, wherein:
the user terminal includes a wireless communication terminal that is able to wirelessly connect to a broadband communication network;
at least one of the repeater device and the connecting device includes a virtual device, at least part of the virtual device being virtualized; and
an individual network to which the virtual device is connected includes a virtual network, at least part of the virtual network being virtualized.

20. A non-transitory computer readable medium storing a program causing a computer to execute a process, the process comprising:
in a network environment including a plurality of individual networks, one or a plurality of devices being connected to each of the plurality of individual networks, a user terminal being connected to one of the plurality of individual networks,
determining a plurality of route options, based on connecting information and configuration information, the connecting information indicating association between the user terminal and a connecting device, the connecting device being one of the plurality of devices and being a device to be connected and used by the user terminal, the configuration information indicating an individual network to which the user terminal is connected and indicating an individual network to which the connecting device is connected, the plurality of route options being options of routes which each connect the user terminal and the connecting device and which each include a repeater device that transfers data between the user terminal and the connecting device;
selecting a route from the plurality of route options, based on load information indicating a load of the repeater device in each of the plurality of route options, the load of the repeater device included in the selected route being smaller than the load of another repeater device; and
controlling connection between the user terminal, the repeater device, and the connecting device included in the selected route so as to send and receive the data in accordance with the selected route.
